(19) United States
(12) Patent Application Publication
(10) Pub. No.: US 2024/0020629 A1
(43) Pub. Date: Jan. 18, 2024

(54) INVENTORY MANAGEMENT SYSTEM PROTECTION FOR NETWORK TRAFFIC SURGE RESISTANT PLATFORM

(71) Applicant: Fevo, Inc., New York, NY (US)

(72) Inventors: Vladimir Mitevski, New York, NY (US); Ari Daie, New York, NY (US)

(21) Appl. No.: 17/865,951

(22) Filed: Jul. 15, 2022

(51) Int. Cl. G06Q 10/08; G06Q 30/06

(52) U.S. Cl. CPC G06Q 10/087; G06Q 30/0641

(57) ABSTRACT

A system and method to manage a surge network traffic targeting a service-hosting platform are disclosed. For an offer of goods and/or services, the platform provider generates a static package that is placed in networked storage that is accessible through a web service interface. The package contains the information required to instantiate and render the interface of the service-hosting platform using the processor and resources of the computer that accesses the package via a browser. Based on the contents of the package, the rendered interface presents the services of the service-hosting platform using resources of the customer's computer without making any calls to a server to query a protected backend system. Access to the protected backend resources and platform resources is gated by threshold actions taken by the user. Additionally, the service-hosting platform protects backend resources that cannot natively mitigate the surge in network traffic.

### RELATED APPLICATIONS

This application is related to U.S. patent application Ser. No. ______ entitled “NETWORK TRAFFIC SURGE RESISTANT PLATFORM,” filed on the same day (Attorney Docket No. 48987-00102), U.S. patent application Ser. No. ______ entitled “A DYNAMIC USER INTERFACE FOR A NETWORK TRAFFIC SURGE RESISTANT PLATFORM,” filed on the same day (Attorney Docket No. 48987-00103), U.S. patent application Ser. No. ______ entitled “INVENTORY MANAGEMENT FOR A NETWORK TRAFFIC SURGE RESISTANT PLATFORM,” filed on the same day (Attorney Docket No. 48987-00104), and U.S. patent application Ser. No. ______ entitled “AUTHENTICATION MANAGEMENT FOR A NETWORK TRAFFIC SURGE RESISTANT PLATFORM,” filed on the same day (Attorney Docket No. 48987-00106), each of which is herein incorporated by reference in their entirety.

### TECHNICAL FIELD

The present invention is generally related to webhosting of electronic commerce and, more specifically, management of surge network traffic to an electronic commerce platform.

### BACKGROUND

Purchasing high demand goods and/or services, such as popular toys or event tickets, can be frustrating for consumers and potentially debilitating for electronic commerce platform providers. Increasingly, merchants use flash sales or other such events where all or part of the available inventory is, for a limited amount of time, offered to a group of people at a special price and/or is offered as an opportunity to purchase before the general public. Merchants may use such events to offer benefits to a particular group of customers (e.g., premium members, students, faculty, etc.), as a form of price differentiation, and/or to capture the attention of highly motivated customers, etc. Sometimes, instead of a preplanned event, consumer interest in a good or service is so high that a similar surge in traffic is generated upon an initial offer of the good or service. In such scenarios, instead of managing infrastructure (e.g., servers, databases, network bandwidth, etc.) for mean site traffic, the merchant's site must be configured to handle relatively infrequent surges of high network traffic volume that include a large number of requests into the merchant's backend infrastructure. For example, a flash sale can act like a denial of service attack, but where the traffic is entirely legitimate. Often, backend systems, such as inventory management systems, are built with older technology that cannot handle the massive volume of queries into its databases. Such backend systems can be overwhelmed by these high traffic value events.

### SUMMARY

Systems and methods for providing an electronic commerce platform that manages surges of high network traffic volume while protecting backend computing resources are described herein. For an offer of goods and/or services, the platform provider generates a static package that is placed in networked storage (e.g., networked object storage, etc.) that is accessible through a web service interface. The package contains the information required to instantiate and render the interface of the store, as well as information that is necessary to complete a transaction. When the offer is electronically communicated via a link, the linked location on the merchant platform's server includes just enough HTML instructions to retrieve the package from the storage and instantiate the interface. Based on the contents of the package, the interface of the merchant platform is then rendered in the browser of the customer using the processor and resources of the customer's computer (e.g., not resources a server of the merchant platform). During this process, the graphical elements of the interface may be retrieved from the networked storage. Based on the contents of the package, the rendered interface presents available inventory and performs cart management (e.g., presenting available inventory, selecting/deselecting goods and/or services to be placed in the cart, etc.) using resources of the customer's computer without making any calls to a server to query an inventory management system. The interface only performs backend calls (e.g., calls to the merchant platform server, etc.) when necessary to complete the next stage of the transaction (e.g., after the customer takes an affirmative step in the transaction). For example, when the customer clicks on an action button that signals that they desire to proceed with checking out, a call to an inventory server to query the relevant inventory management system(s) is made to place a temporary hold on the desired inventory. The rendered interface collects information to authenticate the identity of the customer and collects payment information. The interface then performs backend calls to the relevant system (e.g., the payments system, the customer management system, etc.) to verify the customer's information and process the payment. After the payment is processed and the customer is identified, the merchant platform makes a call to the inventory management system to reserve the goods and/or services for the customer.

The commerce platform maintains a separate inventory data object (sometimes referred to as an “internal ledger” or “parallel ledger”) on which the offer packages are based. When the commerce platform receives or otherwise retrieves the inventory data object from the merchant, the commerce platform reconciles the internal ledger with the inventory data object from the merchant. In such a manner, the commerce platform may generate reasonably accurate offer packages while minimizing the amount that the inventory management system needs to generate the inventory data object. In some examples, the merchant may establish a minimum interval at which the commerce platform may request the inventory data object. In some such examples, the commerce platform waits until it detects evidence that the inventory maintained by the merchant is not in sync with the inventory as tracked by the internal ledger. In some examples, when the commerce platform detects evidence that the inventory maintained by the merchant is not in sync with the inventory as tracked by the internal ledger, it may apply rules to the internal ledger to reconcile the internal ledger with the inventory maintained by the merchant.

An network example traffic surge resistant system includes network storage and one or more servers configured as a commerce platform. At a first time, the commerce platform: (i) generates an internal ledger based on a first version of an inventory data object, (ii) generates a script, an offer package with first inventory slices based on the internal ledger, and an offer instantiator, and (iii) stores the script and the offer package onto the network storage, the offer instantiator providing the location of the script and the offer package in the network storage. At a second time after the first time, the commerce platform: (i) receives an updated version of the inventory data object, (ii) reconciles the updated version of the inventory data object with the internal ledger, (iii) generates a second set of inventory slices based on reconciled internal ledger, wherein generating second set of inventory slices does not cause the commerce platform to generate an update signal to any browsers, and (iv) regenerates the offer package that includes the second set of inventory slices and place the regenerated offer package in the same location in the network storage. In response to a browser operating on a computing device accessing the offer instantiator after the first time or the second time: (i) causing, by the offer instantiator, the browser to retrieve the script and the offer package from the network storage, and (ii) causing, by the script, the browser to instantiate a cart interface within the browser based on the offer package using the resources of the computing device without making a backend call to the commerce platform, the cart interface including a first set of inventory items based on the first set of inventory slices.

An example method for protecting an inventory management system by a network traffic surge resistant platform, includes, at a first time, by one more servers configured to operate as a commerce platform: (i) generating an internal ledger based on a first version of an inventory data object, (ii) generating a script, an offer package with first inventory slices based on the internal ledger, and an offer instantiator, and (iii) storing the script and the offer package onto a network storage, the offer instantiator providing the location of the script and the offer package in the network storage. The method also includes, at a second time after the first time, by the commerce platform: (i) receiving an updated version of the inventory data object from the inventory management system; (ii) reconciling the updated version of the inventory data object with the internal ledger, (iii) generating a second set of inventory slices based on reconciled internal ledger, wherein generating second set of inventory slices does not cause the commerce platform to generate an update signal to any browsers, and (iv) regenerating the offer package that includes the second set of inventory slices and place the regenerated offer package in the same location in the network storage. Additionally, the method includes, wherein, in response to a browser operating on a computing device accessing the offer instantiator after the first time and before the second time: (i) causing, by the offer instantiator, the browser to retrieve the script and the offer package from the network storage, and (ii) causing, by the script, the browser to instantiate a cart interface within the browser based on the offer package using the resources of the computing device without making a backend call to the commerce platform, the cart interface including a first set of inventory items based on the first set of inventory slices. The example method includes, in response to a browser operating on a computing device accessing the offer instantiator after the second time: (i) causing, by the offer instantiator, the browser to retrieve the script and the offer package from the network storage, and (ii) causing, by the script, the browser to instantiate a cart interface within the browser based on the offer package using the resources of the computing device without making a backend call to the commerce platform, the cart interface including a second set of inventory items based on the second set of inventory slices.

### BRIEF DESCRIPTION OF THE DRAWINGS

Operation of the present disclosure may be better understood by reference to the following detailed description taken in connection with the following illustrations, wherein:

FIG. 1 is a block diagram of an example system to provide an electronic commerce platform to manage a surge network traffic, according to the teachings of this disclosure.

FIG. 2 is a conceptual diagram of bricks used to construct a package used to manage the surge network traffic, according to the teachings of this disclosure.

FIG. 3 is a conceptual diagram of the packager of FIG. 1 generating an offer package, according to the teachings of this disclosure.

FIG. 4 is a conceptual diagram of the commerce platform of FIG. 1 publishing the offer package, according to the teachings of this disclosure.

FIG. 5 illustrates an example cart interface, according the teachings of this disclosure.

FIG. 6 is a block diagram of an example system to manage inventory by an electronic commerce platform to protect an inventory management system during a surge network traffic, according to the teachings of this disclosure.

FIGS. 7A and 7B illustrate an example method to provide for a network traffic surge resistant platform, according to the teachings of this disclosure.

FIG. 8 illustrates an example method to manage inventory during a surge network traffic, according to the teachings of this disclosure.

FIGS. 9 and 10 illustrate example methods to protect an inventory management system during a surge network traffic, according to the teachings of this disclosure.

FIGS. 11 and 12, illustrate example methods to manage a parallel ledger to protect an inventory management system during a surge network traffic, according to the teachings of this disclosure.

### DETAILED DESCRIPTION

Reference will now be made in detail to exemplary embodiments of the present disclosure, examples of which are illustrated in the accompanying drawings. It is to be understood that other embodiments may be utilized, and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Commerce platforms that offer high demand and/or limited time offers for good and/or services often require backend systems (e.g., physical and/or virtual servers, databases, network bandwidth, etc.) that are deployed to meet or scale to surges in network traffic as a large number of customers simultaneously attempt to procure the goods and/or services. For example, platforms that handle ticket sales for major events (e.g., sports, concerts, etc.) often see such surges in network traffic as tickets are released. These surges can be orders of magnitude greater than the mean or ordinary network traffic and can overwhelm the commerce platform and its surrounding infrastructure with the flood of Internet traffic. Managing these sources can be costly and error prone, as it depends on recognizing the surge and differentiating the surge from illegitimate traffic (e.g., a denial of service attack, etc.). Additionally, in many cases, some backend systems, such as inventory management systems, are deployed using technology that is hard to scale (if even possible) and cannot handle the volume of requests necessary to service the traffic. For examples, generally scalability must be part of the design of a database and many inventory systems were deployed before scalability was required. This can lead to slowing, instability and/or termination of the operation of the ecommerce platform because the network and the backend system cannot cope or adapt quickly to the surge. Attempted techniques, such as queues and timed inventory reservation systems, etc., are often not effective in mitigating the effects of surge the network traffic and can be used by malicious actors and/or undesirable consumers to deny some or all customers access to purchasing the good and/or services on the commerce platform. Accordingly, there are technical problems that prevent a commerce platform from being able to manage surges in network traffic volume without negatively affecting the backend systems that comprise the commerce platform.

Often, to protect, for example, the integrity of the databases of an inventory management system (IMS), the merchant operating the IMS will limit the amount that the IMS may be access, especially if the access request requires one or more queries into the database. For example, creating a list of available inventory to provide to the commerce platform can be a relatively resource intense process, such that the merchant operating the IMS may further limit the interval or frequency at which such a comprehensive list of inventory can be generated. In some examples, the merchant may establish an upper limit on how many requests can be made in a period of time (e.g., a limit of requests per minute, etc.). Often, these IMS cannot scale or otherwise mitigate the technical limitations of their hardware and software without slowing transactions down. While there is an incentive for the merchant to allow as much traffic as possible (e.g., to sale inventory), the limitations of legacy hardware and software that is not capable of handling a high volume of transactions that accompany a surge of network traffic aimed at the commerce platform is a technical barrier. A commerce platform that is experiencing a legitimate surge of network traffic may risk becoming out of sync with the IMS as transactions are processed and inventory is presented by the commerce platform faster than the IMS can technically handle. Thus, there needs to be a technical system to manage inventory in conjunction with the IMS that protects the integrity of the database of the IMS, protects the commerce platform, and keeps the commerce platform and the IMS in sync during a surge of network traffic.

The term “server” has its ordinary meaning. Generally, a server provides computational services in a request-response model where in response to a request (sometime referred to as a “call”) over a network, the server performs some computational action and sends a response back to the requesting computer. As used herein, a “backend call” refers a request by an interface operating on the computing device of a customer to a non-static network resource (e.g., a server, a database, etc.). A “backend call” generally requires the server(s) of the commerce platform to process the request and generate information to be sent to the requester that is responsive to the contents of the request. For example, the backend call may require a query into an inventory database to determine status of inventory associated with the offer. Through the intensity can vary, backend calls are relatively computationally intensive to network resources. The terms “network storage” and “cloud storage” have their ordinary meaning. Generally, network storage provides object storage through a web service interface to facilitate remote storage and retrieval of data objects. As used herein, a “static call” refers to a request to a static network resource, such as networked storage that stores data objects (e.g., visual elements for an interface, scripts to be executed by the interface, offer packages, etc.). Static calls are relatively computationally inexpensive. As used herein, an “offer instantiator” refers to a document designed to be processed in a web browser that includes (i) structure (e.g., written in HTML code, etc.) necessary to render a cart interface, (ii) a location of where to receive a related offer package (e.g., from networked storage), and (iii) a location to receive a script to render the cart interface using the structure and the offer package.

A merchant that desires to make an offer via a surge traffic resistant commerce platform (“commerce platform”) generates an offer package through the commerce platform. The offer package contains information necessary to render a cart interface and browse inventory associated with the offer without making backend calls to the commerce platform or any inventory management system tracking the inventory associated with the offer. The package may be, for example, generated in a data-interchange format. The packages are then stored on one or more static network storage devices. To communicate the offer, the commerce platform creates a link (e.g., a Uniform Resource Locator (URL), etc.) that points to an address that contains the location of the offer package, the location of the script to render the cart interface, and a minimum amount of code (e.g., HTML, etc.) necessary to use the script to render the cart interface.

When a consumer activates the link, the consumer's browser fetches the offer package and the script to render the cart interface (e.g., by generating browser readable code, etc.) on the commuting device executing the browser. That is, instead of a server (e.g., one of the servers of the commerce platform) generating the cart interface and then sending the browser readable code defining the cart interface to the browser, the computing device of the customer generated the browser readable code for the cart interface using the script and based on the offer package. In such a manner, when a surge of customers are simultaneously or near simultaneously interacting with the cart interface, a corresponding serge of traffic is not generated directed at the servers of the commerce platform and those servers are not overwhelmed by the resulting processing to generate and update the cart interface. The cart interface includes an action button. The browser generated cart interface performs pre-checkout cart management functions using the resources of the browser without making inventory or checkout related backend calls to the servers of the commerce platform until the action button is activated (e.g., “clicked on”) by the customer. These pre-checkout cart management functions include browsing inventory (e.g., names, descriptions, and/or prices of inventory available through the offer, etc.), receiving an indication of the type and/or quantity that the customer desires to purchase, and/or calculating an estimated total cost of the indicated type and quantity. Because the package includes all of the inventory information (e.g., offer details, identities and descriptions of inventory available with the offer, price, etc.), the cart interface performs these pre-checkout functions without making any backend calls. Thus, a surge of customers browsing inventory, many of whom are not likely to complete a purchase, does not create a corresponding surge in network traffic or server load for the commerce platform. From time-to-time, the commerce platform may asynchronously regenerate the offer package to change any part of the offer, including available inventory, the theme or template, etc., to replace the previous package at the same location in the static network storage. Thus, the merchant may dynamically update the cart interface without causes a surge of network traffic or server load.

When the customer activates the action button, the browser renders, based on the offer package, a checkout interface and makes a backend call that includes the identities and quantities of the inventory in the current cart of the cart interface. This backend call causes one of the servers to calculate the actual (e.g., non-estimated) cost, including the unit cost of each item and any associated fees, to the items in the cart and report that total to the checkout interface. The customer may change quantities (e.g., add quantities, subtract quantities, delete items, etc.) in the checkout interface. Each changes results in the backend call to calculate the total cost of the items. These price calculations are performed without querying the inventory management system of the merchant. Thus, a large number of such backend calls does not result in an increased load on the merchant's inventory management system. In some examples, these backend calls are configured to be computationally light to reduce any strain on the servers of the commerce platform.

When the browser receives the calculation, the checkout interface displays the total. The checkout interface performs a redirect to a payment processor. In some examples, this causes the payment processor to instantiate one or more payment electronic widgets (e.g., a Google® Pay widget, an Apple® Pay widget, etc.) and/or a credit card payment widget in the checkout interface. Interacting with one of the electronic payment widgets or the credit card payment widget (e.g., providing payment credentials, etc.) causes the payment processor to generate a payment intent that places a hold on funds equal to the calculated amount. Up to this point, the merchant platform does not make any call to the inventory management system of the merchant. After the payment processor signals that the payment intent was successful, the commerce platform attempts to place a reserve on the items with the inventory management system of the merchant. When the inventory management system signals that the attempt to reserve the inventory was successful, the commerce platform initiates one or more authenticity/security checks (sometimes referred to as “authorization challenges”) with the customer via the checkout interface. When all of the authenticity/security checks are successful, the commerce platform requests that the inventory management system place the reserved items in a fulfillment status. The commerce platform then signals the payment processor to complete the transaction based on the purchase intent. The commerce platform then performs post-purchase fulfillment actions via the checkout interface. In such a manner, the commerce platform minimizes network traffic, server load, and load on the inventory management system by only generating such activity when the customer has affirmatively signaled their desire to complete a transaction and only to the extent necessary for their current level of commitment.

Additionally, the commerce platform maintains an inventory data object (sometimes referred to as an “internal ledger” or a “parallel ledger”) separate from the inventory data object received from the IMS of the merchant. This internal ledger may comprise scaleable technology such that the commerce platform is able to access the internal ledger at a much greater frequency than the IMS. The commerce platform builds an offer package based on the internal ledger and the status of available inventory (e.g., on hold, reserved, marked for fulfillment, etc.) on the internal ledger. From time-to-time, the commerce platform may receive and/or otherwise retrieve an updated version of the inventory data object from the IMS of the merchant. The commerce platform then reconciles the internal ledger with the updated version of the inventory data object such that differences between the two are accounted for. The commerce platform and/or the merchant, to protect the integrity of the IMS, may set a minimum time interval that the commerce platform must wait between requests for an updated version of the inventory data object. In some examples, the commerce platform requests an updated version of the inventory data object when the commerce platform detects evidence that the internal ledger and the inventory data object may be out of sync. For example, the commerce platform may trigger any update when the commerce platform attempts to reserve an inventory item and the IMS responds that the inventory item is not available (e.g., is reserved or is marked for fulfillment, etc.). In some examples, when the IMS limits the number of transactions over a period of time, the commerce platform may predictively request a hold on inventory based on the inventory data object, generate the internal ledger based on the held inventory, process transactions using the internal ledger, and over time, process transactions with the IMS as transaction requests are available. In such a manner, the commerce platform processes transactions that result from a surge in network traffic while protecting the technical limitations of the IMS.

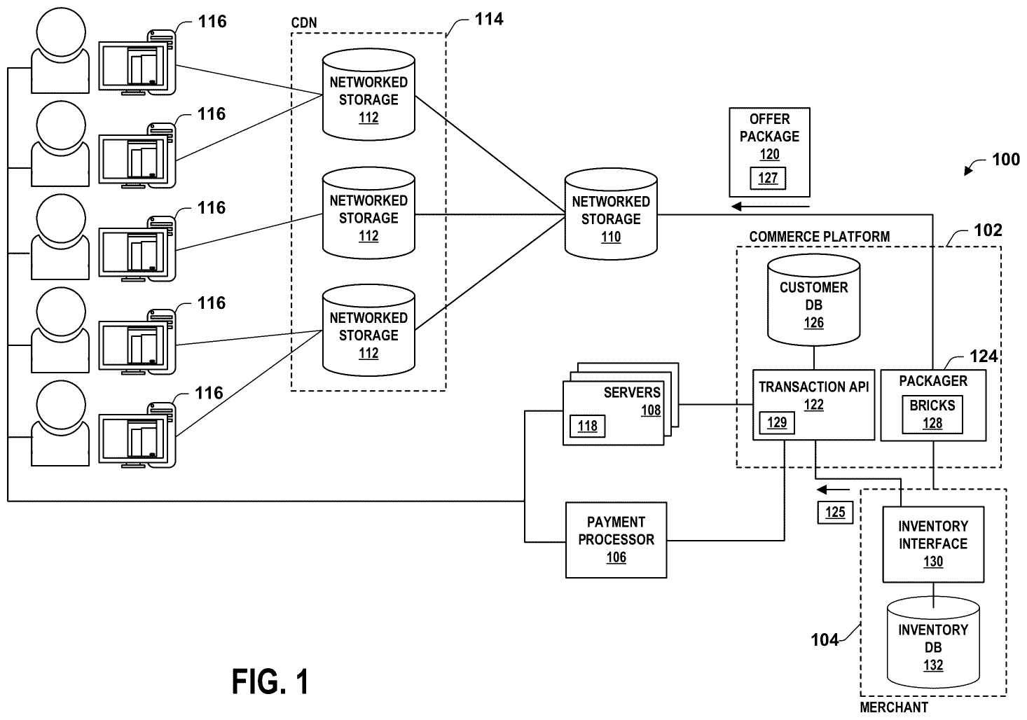

FIG. 1 is a block diagram of an example system 100 to provide an electronic commerce platform 102 to manage a surge network traffic. In the illustrated example, the commerce platform 102 is communicatively coupled merchant networks (e.g., merchant network 104) and payment processors 106. The commerce platform 102 is also communicatively coupled to one or more webservers 108 (e.g., physical servers, virtual servers, and/or virtualized containers, etc.) and one or more network storage devices 110 (e.g., Amazon® S3, Google® Cloud Storage, Azure® Blob Storage, IBM® Cloud Object Storage, etc.). Data objects stored in the network storage devices 110 may be pushed onto network storage devices 112 that part of a content delivery network (CDN) 114 to be accessed by browsers operating on computing devices 116 (e.g., desktop computers, laptop computers, smart phones, tablets, smart televisions, etc.). The commerce platform 102 facilitates generation of offer instantiators 118 and offer packages 120 by a merchant to offer goods and/or services of managed by the merchant network 104 though the commerce platform 102.

The commerce platform 102 includes a transaction application programming interface (API) 122, a packager 124, and a customer database 126. While in the illustrated example, the transaction API 122, the packager 124, the customer database 126, and the webservers 108 are illustrated as being conceptually grouped in a certain configuration for simplicity, these components may be otherwise situated in any suitable manner (e.g., on cloud servers, etc.). The transaction API 122 facilitates communication between the webservers 108, the payment processor 106, the merchant network 104, and the customer database 126. The packager 124 receives input from the merchant to generate the offer instantiator 118 and the offer package 120 using software bricks 128. In some examples, the package 124 generates the offer package 120 in a data-interchange format (e.g., JavaScript Object Notation (JSON), Extensible Markup Language (XML), YAML, etc.). The software brick 128 are offer package components that define the parameters, metadata, available inventory and/or audiovisual assets of the offer and the interrelationship between these parameters, metadata, available inventory and/or audiovisual assets. The customer database 126 stores customer information to facilitate assigning an order from a checkout interface in a browser to a particular account or accounts for security and fulfillment purposes. The structure and organization of the offer package 120 are dictated by which bricks are used to generate the offer package 120.

Using the packager 124, the merchant defines the offer and provides an inventory data object 125 that specifies the available inventory for the offer and attributes of the inventory the merchant uses to distinguish the inventory. In some examples, the inventory data object 125 comprises a two dimensional table with a row for every good or service to be offered or class of goods or services to be offered (e.g., for non-fungible items) with one or more attributes related to the goods or services. For example, the data object may include a row for each seat in a venue that is to be part of the offer, and a column for the section number, a column for the row number, a column for the seat number, and a column for a classification of the seat (e.g., student seating, VIP seating, etc.). From time-to-time (periodically or aperiodically), the merchant 104 may provide an updated inventory data object 125. For example, the packager 124 may request, at an interval no shorter than a refresh interval specified by the inventory management system of the merchant 104 (e.g., where the refresh interval is set to protect the integrity and operation of the IMS), an update to the inventory data object 125. In the illustrated example, the transaction API 122 maintains an internal ledger 129 that the packager 124 uses to generate the offer packages 120 as if the internal ledger 129 reflects the true state of an inventory database of the merchant 104. When an updated version of the inventory data object 125 is received or otherwise retrieved, the transaction API reconciles any differences between the internal ledger 129 and the updated version of the inventory data objection 125 and used the reconciled internal ledger 129 to regenerate the offer packages 120. The request to update the inventory data object 125 may be based on a trigger or a set of triggers. For example, transaction API 122 may maintain a flag that is set when the transaction API 122 attempts to hold or reserve a good or service and receives a response from the inventory interface 130 that the requested good or service is not available, signaling that the inventory database 132 and the internal ledger 129 are out of sync.

The packager 124 generates a unique link (e.g., a URL link, etc.) that instructs a browser where to locate the offer instantiator 118. The offer package 120 contains the information necessary for the offer instantiator 118, when accessed by a browser, to render the cart interface and the checkout interface, including a description of the available inventory, to facilitate a customer browsing the inventory through the cart interface without making any backend calls to the webservers 108 and/or the transaction API 122. As part of generating the offer package 120, the packager 124 pre-processes the internal ledger 129. The packager 124 slices the internal ledger 129 into inventory slices 127. The inventory slices 127 are, as explained below, packaged into the offer package 120. After the offer instantiator 118 and offer package 120 are created, the packager 124 publishes the instantiator 118 onto the webservers 108 and pushed the offer package 118 onto the networked storage 110 and 112. The link to the instantiator 118 may then be provided to customers. In the illustrated example, the instantiator 118 is located on a server and is accessible via a domain that is controlled/operated by the commerce platform 102. Alternatively, in some examples, the instantiator 118 may be located on a server and accessible via a domain that is controlled/operated by another party (e.g., the merchant network 104, a third party, etc.).

The offer package 120 may be regenerated from time-to-time with new and/or updated parameters, metadata, available inventory and/or audiovisual assets of the offer. For example, the offer packager 124 may regenerate the offer package 120 periodically, in response to a change in the parameters and/or metadata associated with any bricks 128 used to generate the offer package 128, and/or in response to significant changes to inventory in the internal ledger 129. For example, the offer packager 124 may regenerate the offer package 120 when the internal ledger 129 indicates that an entire inventory slice 127 is no longer available. When the offer package 120 is rebuilt, the packager 124 pushes the updated offer package to replace the old offer package in the networked storage 110 and 112. In such a manner, the merchant can dynamically and asynchronously update the offer package 130 while customers access the offer instantiator 118 without interruption.

The example merchant network 104 includes an inventory interface 130 and an inventory database 132 (collectively may be referred to as an “inventory management system” or “IMS”). The inventory from which the inventory data object 125 is compiled is stored in the inventory database 132. The inventory interface 130, using the inventory database 132, provides the inventory data object 125. The inventory interface 130 may also manipulate the inventory in the inventory database 132 by, for example, changing the status of the inventory (e.g., reserving the inventory, marking the inventory for fulfillment, etc.). In some examples, because too frequent compilations of inventory may cause the degradation or loss of operation of the IMS (e.g., the inventory database 132) and/or may interfere with ability of the IMS to change the status of the inventory as purchases are made, the inventory interface 130 may set a refresh interval limit the frequency at which the packager 124 may request a refresh of the inventory data object 125. That is, the inventory database 132 may not be capable of handling transactions at the rate they are generated by the surge of network traffic. For example, the refresh interval may be set such that the minimum amount of time that the transaction API 122 may request the inventory data object 125 is three minutes. Additionally, in some examples, the inventory interface 130 may establish a maximum number of requests per a time period (e.g., 200 requests per minute, etc.). However, for example, to complete a transaction, the transaction interface 122 may need to make ten requests to the inventory interface 130. In some examples, the transaction API 122 may use the periodically reconciled internal ledger 129 as the basis of performing transactions while completing transactions through the inventory interface 130 as requests are available.

When a consumer activates the link to the offer instantiator 118, the consumer's browser performs a static call to retrieve the offer package 120 and the script to render the cart interface (e.g., by generating browser readable code, etc.) from the network storage 110 and 112. The browser then renders the cart interface by executing the script using the offer package 120, including populating the available inventory in the cart interface based on the inventory slices 127. This available inventory does not change through direct updates or making a backend call for the update. The browser generated cart interface performs pre-checkout cart management functions using the resources of the browser. These pre-checkout cart management functions include browsing inventory (e.g., names, descriptions, and/or prices of inventory available through the offer, etc.) as defined by the inventory data object (e.g., as processed by the bricks 128).

From time-to-time, the browser may refresh access to the offer instantiator 118. For example, the user may refresh the browser or the browser may receive a signal to refresh access to the offer instantiator in response to making a backend call. Then the browser refreshes access to the offer instantiator 118, the browser performs a static call to retrieve the offer package 120 and the script to render the cart interface from the network storage 110 and 112. If the offer package 120 has been updated since the last time the offer package 120 was retrieved, the offer instantiator will cause the browser to retrieve the updated offer package 120. The browser then renders the cart interface by executing the script using the updated offer package 120, including any updated inventory slices 127.

When the customer activates the action button, the browser renders, based on the offer package 120, a checkout interface and makes a backend call that includes the identifiers (sometimes referred to as “inventory unit identifiers) that identify inventory in the current cart of the cart interface and quantities of the inventory in the current cart of the cart interface. This backend call causes one of the servers 108 to calculate the actual (e.g., non-estimated) cost, including the unit cost of each item and any associated fees, to the items in the cart and report that total to the checkout interface. The customer may change quantities (e.g., add quantities, subtract quantities, delete items, etc.) in the checkout interface. Each changes results in the backend call to the servers 108 to calculate the total cost of the items.

When the browser receives the calculation, the checkout interface displays the total. The checkout interface performs a redirect to the payment processor 106. In some examples, this causes the payment processor 106 to instantiate one or more payment electronic widgets (e.g., a Google® Pay widget, an Apple® Pay widget, etc.) and/or a credit card payment widget in the checkout interface. Successfully credentialing through one of the electronic payment widgets or the credit card payment widget causes the payment processor 106 to generate a payment intent that places a hold on funds equal to the calculated amount. After the payment processor 106 signals that the payment intent was successful, the transaction API 122 attempts to place a reserve on the items with the inventory management system. When the inventory management system signals that the attempt to reserve the inventory was successful, the transaction API 122 initiates one or more authenticity/security checks with the customer via the checkout interface. When all of the authenticity/security checks, the transaction API 122 requests that the inventory management system place the reserved items in a fulfillment status. The transaction API 122 then signals the payment processor 106 to complete the transaction based on the purchase intent. The transaction API 122 then performs post-purchase fulfillment actions via the checkout interface.

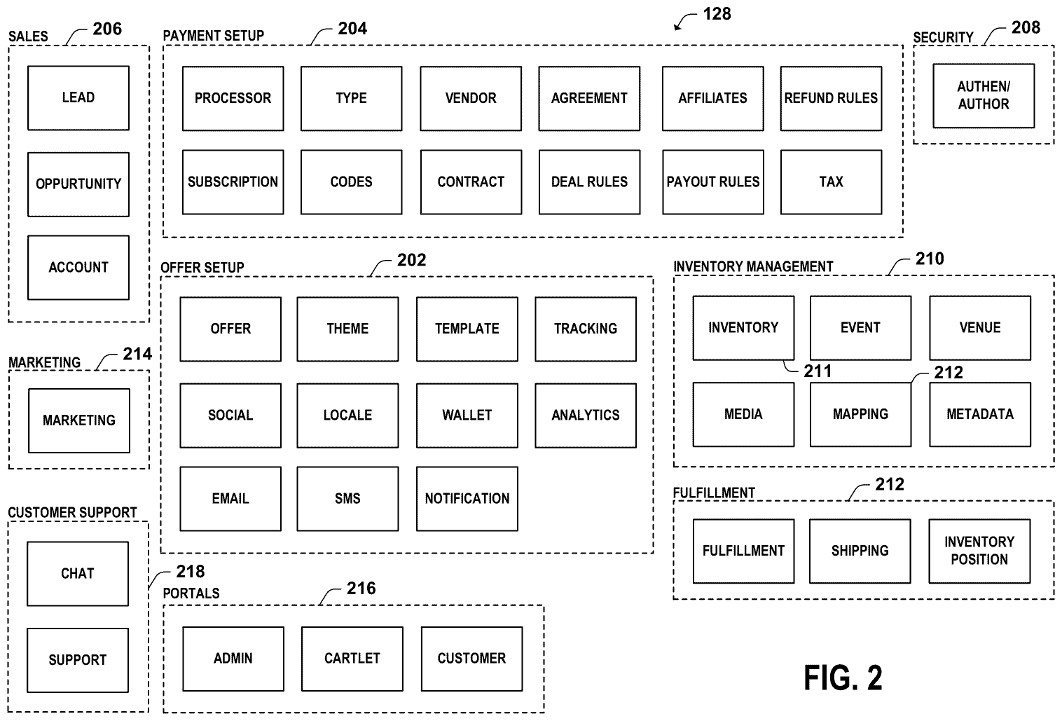

FIG. 2 illustrates examples of the bricks 128 used to define and construct the offer package 120. The bricks 128 are software structures that define the parameters, metadata, available inventory and/or audiovisual assets of the offer, the interrelationship between these parameters, metadata, available inventory and/or audiovisual assets, and the syntax of the data interchange format in which the package 120 is being created. The bricks 128 may have different versions representing different structures that may be selected depending on the desired structure of the offer package. When creating the offer package 120, the merchant may select the relevant bricks 128 to define the look and feel, the functionality, inventory management and grouping, and the order flow associated with the cart interface that is rendered using the offer package 120 constructed using the bricks 128 selected and populated by the merchant. The bricks 128 facilitate building the offer package 120 so to include the necessary parameters, metadata, available inventory and/or audiovisual assets of the offer and/or tokens point to the parameters and/or metadata to perform front end actions (e.g., the computing device 116 rendering the cart interface for the offer) and to perform backend actions (e.g., handle payment, refunds, fund allocation, customer service, etc.). In the illustrated example, the bricks 128 are arranged in thematic groups. However, the bricks 128 may be arranged in any manner. For example, when the packager 124 packages the selected bricks 128, into the offer package 120, the resulting structure of the offer package 120 mirrors the bricks 128. In some examples, the bricks 128 define interface elements that translate the structure of the bricks into interactable objects within an interface to design an offer. The interactable objects have inputs that facilitate receiving the information necessary to render the component of, for example, the cart interface and define relationships between the bricks 128. As such, as bricks 128 are added to an offer, a corresponding interface in an offer editor is generated.

In the illustrated example of FIG. 2, a group of bricks 128 is classified in an offer setup group 202. The bricks 128 in the offer setup group 202 are used to build the look and feel of the cart interface as well as the operation of the cart interface related to the specific offer. A group of bricks 128 is classified in a payment setup group 204. The bricks 128 in the payment setup group 204 are used to define rules for a transaction made of the specific offer and establish a transactional route and history for every good and/or service purchased through the offer. A group of bricks 128 is classified in a sale group 206. The bricks 128 in the sales group 206 interface with external to connect offers to the merchant and facilitate merchant account management. The offer setup group 202, the payment setup group 204, and the sales group 206 contribute structure and metadata to the offer package 120 to facilitate forensically tracing and justifying any transaction that is made according to the offer package 120 and to supply a system with information to complete a transaction while minimizing the transaction's use of backend calls.

In the illustrated example, a group of bricks 128 is classified in a security group 208. Bricks 128 in the security group 208 provide parameters and metadata for performing the multiple security check to authenticate a customer and check if the customer is authorized to perform the transaction. A group of bricks 128 is classified in an inventory management group 210. Bricks 128 in the inventory management group 210 provide parameters and metadata for slicing and presenting inventory in the cart interface and interfacing with the inventory management system of the merchant. An inventory brick 211 provides a connector between the packager 124 and the IMS of the merchant 104 (sometimes referred to as an “adapter”). The inventory brick 211 includes, for example, specific API calls and limitations and/or parameters for those calls for the specific IMS of the merchant 104. For example, the inventory brick 211 may track the number of requests available to the inventory interface 130 and/or track the trigger to request an updated inventory data object 125 from the inventory interface 130. In some examples, the packager 124 may include multiple inventory bricks 211 when multiple merchants 104 and/or multiple IMSs are involved in the offer. The inventory brick 211 retrieves or otherwise receives the internal ledger 129 based on the inventory data object 125 from the IMS of the merchant 124. One of the parameters of the inventory brick 211, for example, may be the refresh interval specified by the IMS of the merchant 104 to limit the frequency the packager 124 may request the inventory data object 125. A mapping brick 212 receives the internal ledger 129 and facilitates the merchant 104 and/or the commerce platform 102 into slicing the internal ledger 129 into the inventory slices 127 to be included in the offer package 120 such that (a) the corresponding inventory is arranged/organized in the cart and/or checkout interface and (b) inventory has an appropriate quantity picker assigned in the cart and/or checkout interface, etc. A group of bricks 128 is classified in a fulfillment group 213. Bricks 128 in the fulfillment group 128 provide parameters and metadata for fulfilling and delivering inventory after a successful transaction. A group of bricks 128 is classified in a marketing group 214 to provide support to attributing sales of goods and/services to parties involved in completing the transaction (e.g., first party or third party sales agents, etc.). A group of bricks 128 is classified in a portals group 216. Bricks 128 in the portals group 216 provide top level structure to packages, including the offer package 120. A group of bricks 128 is classified in a customer support group 218 that includes structure, parameters, and metadata to render a customer support interface and to process customer support requests while minimizing the number of backend calls the customer's browser performs.

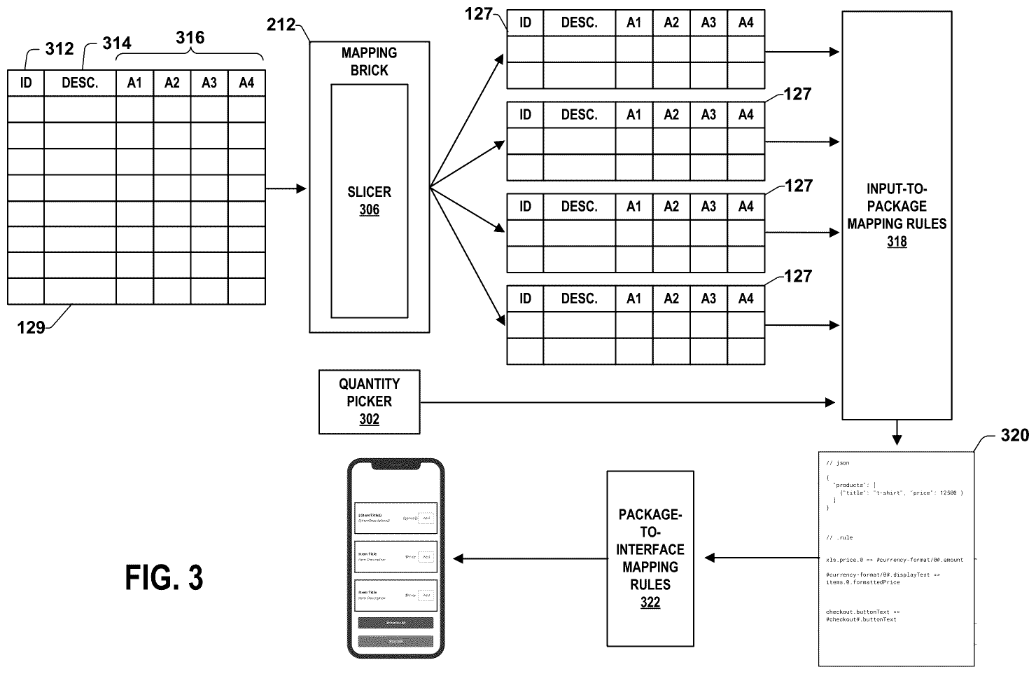

FIG. 3 is a conceptual diagram of the packager 124 of FIG. 1 generating the offer package 120. The packager 124 uses a plurality of bricks 128 to define the content of the offer package 120 and the structure of the offer package 124 that will be used to instantiate the cart and checkout interfaces using the resources of the computing devices 116 of the user accessing the corresponding offer instantiator 118. The merchant 102 interaction with the packager 124 through a packager interface that facilitates editing of the contents and structure of the offer package 120. The packager interface includes selectors to facilitate selection of which bricks 128 (e.g., and which subbricks, etc.) to use to generate the offer package 120 and edit the parameters and metadata associated with each of the selected bricks 128. These selectors may be graphical elements that are dragged and moved in the packager interface to select the bricks 128 and to define relationships between the bricks 128. For example, the bricks 128 may specify different widgets, different quantity pickers 302, different themes, different templates, define audio and/or visual assets to be used, and/or different ways to slice inventory, etc. (collectively referred to as “elements”). For example, the widgets define interactive interface elements in the cart interface that causes the hosting browser to perform an action that reaches externally from the browser (e.g., make a backend call, make a call to the payment processor 106, etc.). For example, one widget may define the parameters (e.g., size, shape, position, label, etc.) of the action button. As another example, one widget may define which third party payment processor to send information to facilitate instantiation of the payment processor's payment interface in the checkout interface.

In the illustrated example of FIG. 3, the mapping brick 212 includes a slicer 306. The slicer 306 facilitates transforming the internal ledger 129 of the inventory to be included in the offer package 120 into slices of inventory 127 that have common attributes and are to be organized in the cart interface together with and each associated with a quantity picker 302. The slices 127 may further be subdivided by the slicer 306 to form a hieratical set of sliced inventory, for example in a tree structure, where the bottom slices are assigned a quantity picker 302. The internal ledger 129 includes a unique identifier 312, supplied by the inventory data object 125, for each inventory item or class of inventory item. For example, fungible items and/or services (e.g., such as clothing, consumables, etc.) may have an identifier that is associated with all items of the class (e.g., all shirts of the same cut, color, and size may have the same identifier, etc.), while pseudo-fungible and/or limited edition goods or services have unique identifiers. The internal ledger 129 includes a description 314, supplied by the inventory data object 125, that provides a human-readable description of the goods and/or services. The internal ledger 129 includes attributes 316, supplied by the inventory data object 125, that distinguish the goods in some way (e.g., descriptively (such as color, location, quality, etc.) and/or organizationally (such as discounts, relations, intangible quantifier, etc.). For example, the attributes may include a price, a group identifier, a color, a size, shape, one or more location related attributes, etc. The slicer 306 transforms the internal ledger 129 into the slices of inventory 127 based on the attributes 316 as designated via the mapping brick 212 by the merchant.

In the illustrated example of FIG. 3, the packager 124 includes input-to-package mapping rules 318 that transform the widgets (e.g., the quantity picker(s) 302), other elements (e.g., themes, templates, and/or audio and/or visual assets to be used, etc.), and, in the illustrated example, the inventory slices 127 into a data interchange formatted file 320 for the offer package 120. The mapping rules 308 map the sliced inventory 127 to quantity pickers 302, and other information defined by and through the bricks 128 (e.g., the widgets 304 and the elements 306, etc.), and translate the mapped sliced inventory 127 into syntax of the data interchange format such that all of the data required to build the cart interface and the checkout interface, all of the data to perform cart management functions (e.g., displaying inventory being offered, prices, and descriptions; manipulating quantities in the cart; estimating total price, etc.) are included in the offer package 120.

In the illustrated example, the data interchange formatted file 320 is a process with package-to-interface rules 322 that specify how the elements will be graphically laid out by the cart interface and/or checkout interface based on, for example, the selected theme and template bricks and the target browser in which the interfaces will be created. For example, the package-to-interface rules 322 may define how the inventory slices 127 and the associated quantity pickers 302 are laid out on the available screen of the target browser taking into account space and processing limitations inherent in some computing devices, such as mobile devices. In some examples, the data interchange formatted file 320 may be processed by different sets for package-to-interface rules 322 to generate different versions of the offer package 120, where the offer initiator 120 causes the browser to download one of the versions of the offer package 120 based on the qualities of the browser. For example, a set of package-to-interface rules 320 may generate one offer package 120 for browsers operating on mobile devices (e.g., smart phones, smart watches, etc.), one offer package 120 for browsers operating on computing devices (e.g., desktop computers, tablets, laptop computers, etc.), and one offer package for browsers operating on mixed reality devices (e.g., virtual reality headsets, augmented reality headsets, etc.). That is, the package-to-interface rules 322 are configured to take into account limitations that are inherent in the computing device 116 that is operating the browser, such as limited screen area, existence of a touchscreen, processing power, and/or network bandwidth availability, etc. Because the input-to-package rules 318 are processed separately from the package-to-interface mapping rules 322, the rules sets 318 and 322 can be updated asynchronously. That is, the template bricks may be updated and the update will be implemented the next time the offer package 120 is published.

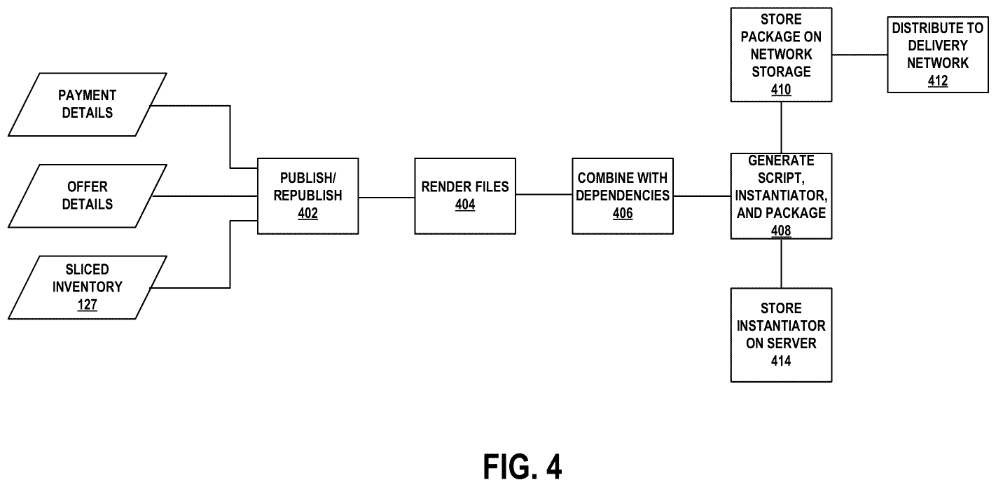

FIG. 4 is a conceptual diagram of the commerce platform 102 of FIG. 1 publishing the offer package 120 and the offer instantiator 118. The commerce platform 102 may asynchronously publish a republish of the offer instantiator 118 and the offer package 120 without regard to computing devices 116 instantiating the cart and/or checkout interface. At block 402, the entity using the commerce platform 102 (e.g., the merchant 104, etc.) indicates that the offer instantiator 118 and/or the offer package 120 should be published or republished. For example, a “publish” button may be provided in the packager interface. In some examples, republishing the offer package 120 may be based on one or more automated triggers. For examples, the offer package 120 may republish upon receipt of an updated version of the inventory data object 125, in response to a set number of updates to the internal ledger 129, and/or when the internal ledger 129 indicates that particular inventory slice 127 is no longer available, etc. To start the process of publishing the offer instantiator 118 and the offer package 120, the packager 124 pulls in the template, the theme, the relevant metadata and parameters from the bricks and, in the illustrated example, the inventory slices 127. At block 404, the packager 124 renders the offer package 120. In some examples, the packager 124 renders the offer package 120 in accordance to the process described in connection with FIG. 3 above. The packager 124 may perform this rendering multiple times to generate offer packages 120 to be used by different browsers. At block 406, the packager 124 retrieves dependencies that are specified by the bricks 128 used to create the offer package 120. The dependencies may be, for example, libraries, audio and/or visual files (e.g., as designated by the selected template brick, the selected theme brick, and/or the selected quantity picker brick, etc.), and/or link paths (e.g., URLs, etc.), etc. Because bricks 128 can be updated asynchronously, deficiencies that may have changed since the last time the offer package 120 was published automatically have those dependencies updated in an offer package when it is republished. At block 408, the packager 124 generates the offer package(s) 120, the script used by the browser to generate the cart and checkout interfaces, and the offer instantiator 118 to be distributed. In some examples, the packager 124 may perform versioning of the offer package(s) 120 and the script each time the offer package(s) is/are republished. The offer instantiator 118 may be changed to point the browser to the updated script and/or updated offer package(s) 120 when the browser refreshes. At block 410, the packager 124 stores the script, the offer package(s) 120, and/or any assets necessary to render the cart interfaces to the network storage 110. To prevent network traffic, especially to a large number of applicable computing devices 116, the packager 124 does not notify any of the computing devices 116 operating browsers in which the cart and/or checkout interface is instantiated that the offer package 120 is being published/republished. At block 412, the package 124 causes the script, the offer package(s) 120, and/or the assets to be distributed to the networked storage 112 in the CDN 114. In some examples, the packager 124 sends a signal to the CDN 114 invalidating the current cache, which causes the network storage 112 in the CDN 114 to update to the latest files. At block 414, the offer instantiator 118 is moved the server(s) 108 to me accessed by the computing devices 116.

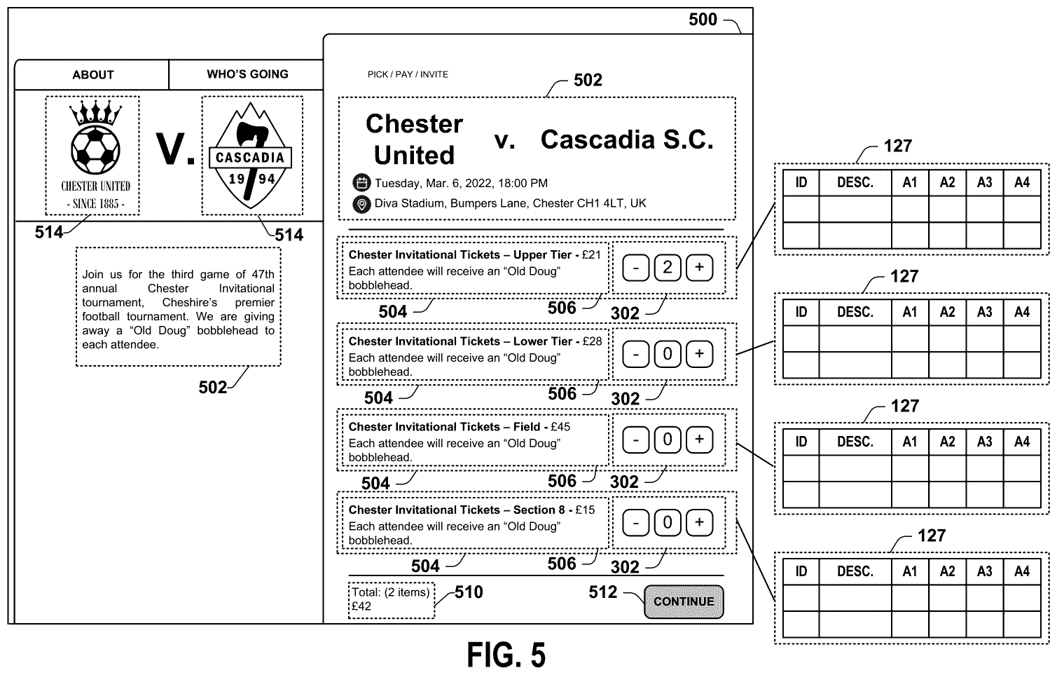

FIG. 5 illustrates an example cart interfaces 500 generated by a browser operating on a computer device 116 in response to being directed to the offer instantiator 118 based on the instantiating script and the offer package 120. In the illustrated example of FIGS. 5, the offer instantiator 118 causes the browser to fetch the instantiating script and offer package 120 to instantiate the cart interfaces 500 for a desktop browser. However, in some examples, the offer instantiator 118 may cause the browser to fetch the instantiating script and offer package 120 to instantiate the cart interfaces 500 for different browser interface (e.g., an interface for a mobile browser, an interface for a smartwatch, an interface for a mixed reality headset, etc.) when the instantiator 118 is accessed by a browser operating on a particular type of device (e.g., a smartphone, a smart watch, a mixed reality headset, etc.). Different interfaces generated by the script may have the same elements 502, 504, 506, 510, 512, and 514 that are rearranged and contextualized, by the script and/or the contents of the offer package 120 to use the browser resources available (such as screen space, input method, processing power, bandwidth availability, etc.). For example, the elements 502, 504, 506, 510, 512, and 514 of the cart interface may be differently arranged differently in browsers operating on different types of devices to present the same information in a manner that takes into account the limited space on which to display an interface on a mobile device. Once the offer package 120 are loaded in a browser, the instantiating script generates the code and makes the necessary calls to instantiate the cart interface 500 and perform cart management functions without making a backend call. The quantity picker 302 may different between the cart interfaces 500 instantiated in different types of browsers (or browsers operating on different typed of devices). From time-to-time, the commerce platform 102 may asynchronously update the offer package 120 and/or the instantiating script. In response to the regenerating the offer package 120 and/or the instantiating script, the commerce platform 102 does not generate a signal to the browser to instruct the browser to refresh. The browser updates the cart interface 500 in response to an event that causes the browser to re-fetch the offer package 120 and/or the script (e.g., the user instructing the browser to refresh, the commerce platform 102 sending a refresh instruction in response to the user's actions, etc.).

As described in FIGS. 3 and 4 above, the office package 120 includes the inventory slices 127 in the offer package 127 and structures the inventory slices 127 such that the elements of the inventory data objects 125 have corresponding elements 302, 504, and 506 in the cart interface 500. In the illustrated examples, the cart interface 500 includes a high level description 502 of the inventory and an inventory item 504 for each inventory slice 127 in the offer package 127 The high level description 502 provide details that are generally applicable to all of the inventory items 504 (e.g., a title for the offer, a date, time and/or location relevant to the offer, etc.). In the illustrated example, each of the inventory items 504 corresponds to one of the inventory slices 127. While for illustrative purposes, only a limited number of inventory items 504 are shown, the cart interface 500 may include as many inventory items 504 as the inventory slices 127 that are defined in the offer package 120. The inventory item 504 includes a description 506 of the inventory being offered corresponding to the description 314 and/or the attributes 316 from the inventory data object 125.

In the illustrated example, the inventory slices 127 define a set of pseudo-fungible goods that, for the purposes of the cart interface 500, are interchangeable. The example inventory slices 127 include multiple rows from the inventory data object 125 (sometimes referred to as a “pool of inventory”), each row representing a unique good or service (e.g., a ticket for a particular seat in a venue, a particular non-fungible token, a particular limited edition item, etc.) that has one or more attributes 316 in common (such as, price, region of the venue, target consumer, etc.). As such, each inventory item 504 represents one of these pools of inventory. As the offer package 120 is updated with changes to the inventory slices 127, the script may cause the browser to instantiate more or fewer inventory objects 504 based on the updated inventory slices 127 in the updated offer package 120.

Each of the inventory items 504 is associated with a quantity picker 302 as defined in the offer package 120. When the quantity of items in the quantity picker 302 is changed, the browser, without making a backend call, estimates the total amount based on the information in the offer package 120 and displays the estimated total in a total field 510. Because this calculation is done entirely within the browser: (a) the calculation is quick, and (b) the manipulating of the inventory in the cart interface 500 does not result in traffic being directed to the commerce platform 102 and does not result in any queries into the IMS of the merchant 104. Using the script, based on the offer package 120, this cart management is repeated until the customer interacts with the action button 512. In this manner, the customer may browse the inventory items 504 and add items to the cart without any traffic being directed at the commerce platform 102.

The look and feel of the cart interface 500 is dictated by the selected template brick and the selected theme brick. The template brick dictates how the script, in conjunction with the offer package 120, generates code to define the layout of elements 502, 504, 506, 302, 510, 512, and 514 within the cart interface 500. If, during block 402 of FIG. 4, the merchant were to select a different template brick or the template brick definition changed (e.g., changes that would take effect in block 406 of FIG. 4), when the customer refreshes the browser, the script, in conjunction with the offer package 120, would generate a changed layout. The selected theme brick dictates the aesthetic look and feel (e.g., color, audio visual assets 512, etc.). If, during block 402 of FIG. 4, the merchant were to select a different theme brick or the theme brick definition changed (e.g., changes that would take effect in block 406 of FIG. 4), when the customer refreshes the browser, the script, in conjunction with the offer package 120, would generate a different look and feel of the cart interface 500.

The cart interface 500 is different from the checkout interface. The cart interface 500 does not, until the action button 512 is interacted with, provide a method for the browser, during the course of the user browsing the inventory, to perform backend calls. Thus, in the cart interface 500, selecting and deselecting inventory (e.g., via the quantity picker 302), does not result in network traffic directed towards the commerce platform 102. Additionally, in some examples, actually purchasing the selected inventory cannot be accomplished through the cart interface 500 (e.g., purchasing is gated by proceeding to the checkout interface, etc.). As a result, a large number of user can simultaneously interact with a cart interface 500 instantiated entirely in their own browser without causing any network traffic to be directed towards the commerce platform 102. The checkout interface facilitates the browser receiving a calculation of actual cost of the selected inventory (via low processing-load backend calls to the commerce platform 102) and initiating purchase of the inventory (via interaction with a checkout button). Until an actual purchase of inventory is initiated (e.g., the user interacting with the checkout button), the checkout interface does not cause any queries into the IMS database 132.

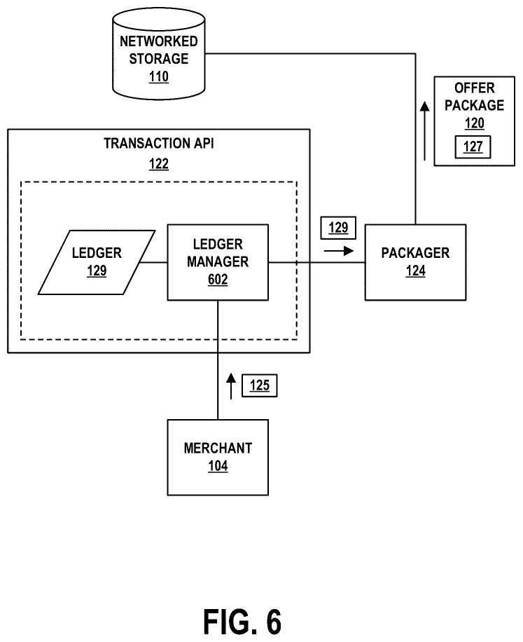

FIG. 6 illustrates a block diagram of the transaction API 122 managing an internal ledger 129 based on the inventory data objects 125 received from the merchant 104. In the illustrated example, a ledger manager 602, as service executed by the transaction API 122, receives or otherwise retrieves the inventory data object 125 and reconciles the internal ledger 129 with the updated version of the inventory data object 125. Retrieval of an updated version of the of inventory data object 125 by the ledger manager 602 is done according to rules set by the ledger manger 602 (sometimes referred to as “internal rules”) and/or rules set by the inventory interface 130 (sometimes referred to as “external rules”). From time-to-time, the available inventory as represented in the internal ledger 129 may become out of sync with the available inventory as exists in the inventory database 132 (sometimes referred to as a “transaction sync error”). The transaction API 122 determines that there is transaction sync error when it attempts to reserve a seat that is categorized as available by the internal ledger 129 but is refused because the inventory interface 130 indicates that it is unavailable. In some example, in response to detecting the transaction sync error, the ledger manager 602 sets a refresh flag that may be used when determining whether to request an updated version of the inventory data object 125.

The inventory interface 130 may impose limitations on requests for an updated version of the inventory data object 125 (e.g., the external rules). In some examples, the inventory interface 130 may set a refresh internal which defines the minimum interval of time between requests by the transaction API 122 for an updated version of the inventory data object 125. For example, the inventory interface 130 may set the refresh interval to be three minutes. In some examples, the inventory interface 130 may limit a number of transactions per minute that the transaction API 122 may perform, where requesting an updated version of the inventory data object 125 counts for a large number of those transactions. In some examples, the inventory interface 130 may both (a) limit a number of transactions per minute, and (b) define the refresh internal. These external rules may be defined or otherwise imported, for the ledger manager 602 to follow, in the inventory brick 211.

The ledger manager 602 is configured to make requests to the inventory interface 130 in accordance to any external rule defined in the inventory brick 211. In some examples, the ledger manager 602 may be configured to follow internal rules as defined in the inventory brick 211. Internal rules may be defined when no external rules have been defined. In some examples, internal rules may be defined to work in conjunction with the external rules. The internal rules may define the refresh interval and/or a trigger that causes the ledger manager 602 to request an update. In some examples, the ledger manager 602 may use both the refresh interval and the trigger. In some such examples, when the refresh interval has passed since the last request, the ledger manager 602 determined whether the refresh flag is set. When the refresh flag is set, the ledger manager 602 requests an updated version of the inventory data object 125 and resets the refresh flag. When the refresh flag is not set, the ledger manager either (a) periodically checks the state of the refresh flag or (b) is triggered when the refresh flag is set to request an update. In some examples, the ledger manager 602 may trigger or set the refresh flag in response to detecting a threshold number of transaction sync errors. For example, when the refresh interval elapses, the ledger manager 602 sets an interval flag and requests an updated version of the inventory data object 125 when both the interval flag and the refresh flag are set.

In some examples, when the inventory interface 130 publishes an external rule that limits the number of transactions per minute that the transaction API 122 may perform, the ledger manager 602 defines one or more rules to limit requests for an update version of the inventory data object 125. For example, the ledger manager 602 may (i) impose a minimum time interval between requests, (ii) make a request in response to a threshold number of transaction sync errors, and/or (iii) may a determination of when to incur the transactional cost of the request based on factors, such as transaction volume generated by the network traffic surge, the number of transaction sync errors, transaction completion pacing, etc.

Transaction sync errors cause the ledger manager 602 to update the internal ledger 129. In some examples, the update depends on the status of the inventory that the inventory manager 130 indicates is unavailable. For example, when the inventory manager 130 responds that the requested inventory has a “hold” status (e.g., the inventory is unavailable as it might be reserved in the relative near future and/or is part of a potential transaction), the ledger manager 602 may mark it as available until it is listed as reserved or until it is involved in a transaction by the commerce platform 102. As another example, when the inventor manager 103 responds that the requested inventory has a “reserved” or “fulfilled” status (e.g., the inventory is unavailable because it has been purchased), the ledger manager 602 may mark it as unavailable. When an updated version of the inventory object 125 is received, the ledger manager 602 reconciles any differences between the updated version of the inventory object 125 and the internal ledger 129. In some examples, the ledger manager 602 replaces the internal ledger 129 with the updated version of the inventory object 125. In some examples, the internal ledger 129 includes rules based on the status of inventory in the updated version of the inventory object 125. For examples, inventory that has the “hold” status may be marked as available and inventory with a “reserved” or “fulfilled” status may be marked as unavailable. In some examples, the updated version of the inventory data object 125 may be a cached version of the state of the relevant portions of the inventory data 132. That is, in such examples, the inventory manager 130 may generate the inventory data object 125 periodically where the state of the inventory data object 125 may not be an accurate reflection of the current state of the inventory database 132. In some such examples, the inventory manage 602 may reconcile inventory with the “hold” status in the updated version of the inventory data object 125 based on the time that has elapsed since the update version of the inventory data object 125 was created. For example, the ledger manager 102 may (i) mark inventory with the “hold” status in the updated version of the inventory data object 125 as temporarily unavailable in the internal ledger 129, causing the inventory object to not be included in the inventory slices 127 for a predefined amount of time (e.g., one minute, two minutes, three minutes, etc.) when the elapsed time is lower than a threshold time, and (ii) mark inventory with the “hold” status in the updated version of the inventory data object 125 as available in the internal ledger 129 when the elapsed time is greater than or equal to the threshold time.

In some examples, the ledger manager 129 creates the internal ledger 129 based on, but not directly from, the inventory data object 125. In some examples, after the offer is created (i.e., the bricks 128 are selected and populated, etc.), the ledger manager 129 may request the inventory data object 125. Based on the status of inventory as represented by the inventory data object 125, the ledger manager 129 may algorithmically requests holds on as much inventory as available that is part of the offer. For example, because the inventory data object 125 may be the most currently generated inventory data object 125 but not necessarily reflect the current state of the inventory database 132 (e.g., may have a lag due to a cache rate, etc.), the ledger manager 129 may perform a search-like algorithm (e.g., a binary search algorithm, a jump search algorithm, an interpolation search algorithm, etc.) to determine the maximum amount of inventory that it can place a hold on by requesting holds on amounts of inventory, reformulating requests when the inventory manager 130 responds that the requested inventory cannot have “hold” status placed on it. The ledger manager 129 may perform this, for example, when the goods are pseudo-fungible and/or have a relation with each other, such as tickets for specific seats in a venue. The ledger manager 129 constructs the internal ledger 129 using the inventory it was successfully able to place into the “hold” status. In such examples, transactions as described herein convert inventory from the “hold” status to the “reserved” status as part of the transaction. Subsequently, the ledger manager 602 treats the internal ledger 129 as if it reflects the true state of the inventory database 132.

The ledger manager 602 provides the internal ledger 129 to the packager 124. The packager 124 generates inventory slices 127 based on the internal ledger 129 and generated the offer package 120 as described in connection with FIGS. 3 and 4 herein. Receiving an undated version of the inventory data object 125 may trigger the packager 124 to regenerate the offer package 120.

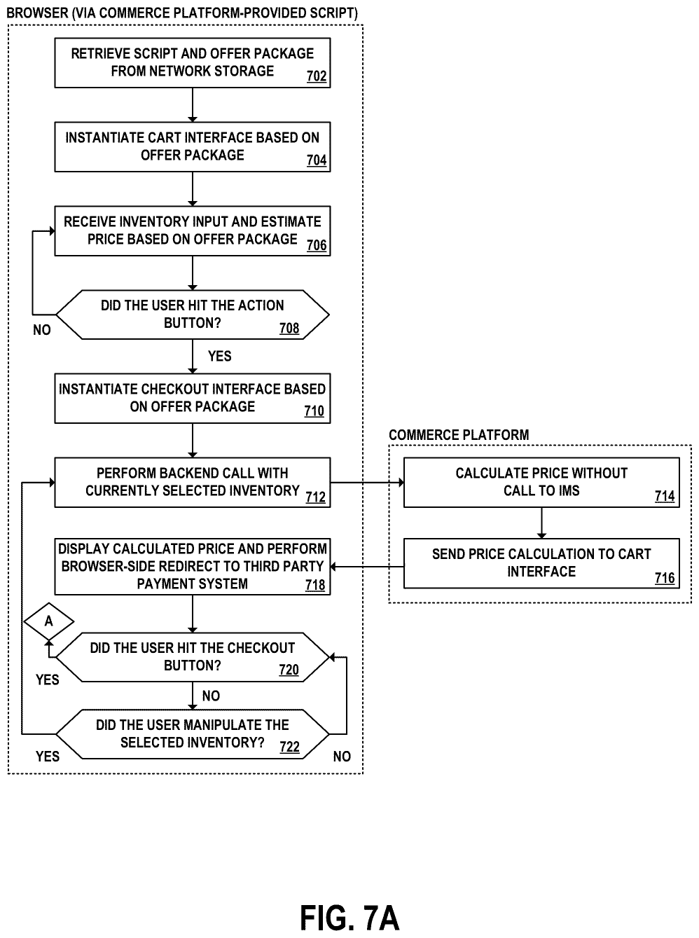

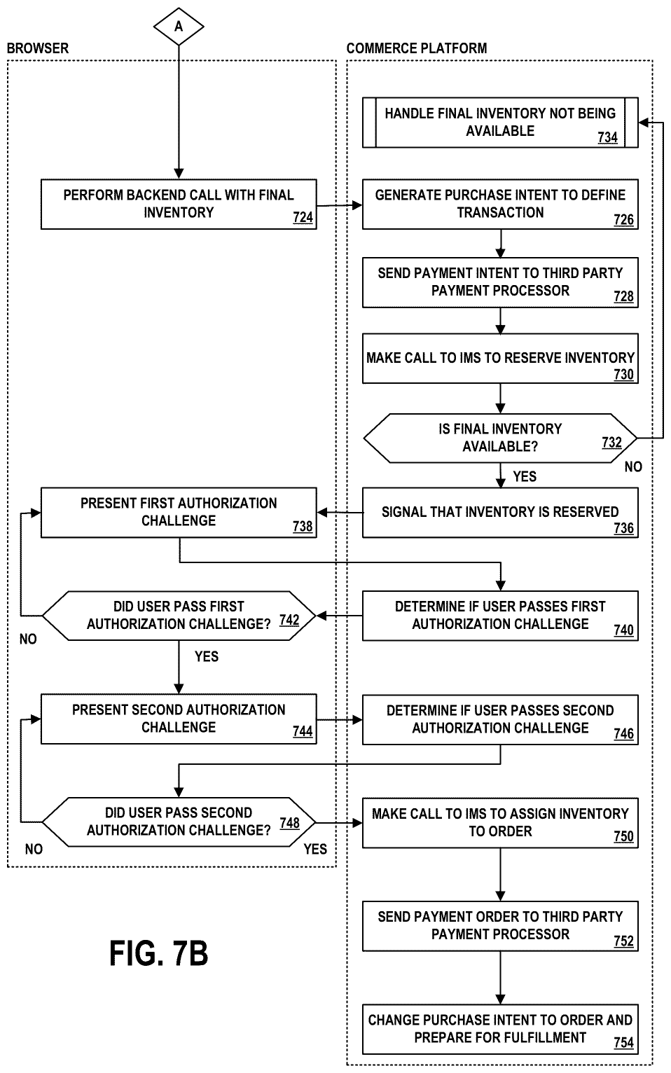

FIGS. 7A and 7B illustrate an example method to provide for a network traffic surge resistant platform. The method begins when a user loads the offer instantiator 118 into a browser. For example, the user may click on a URL that directs the browser to the offer instantiator 118. Generally, the method minimizes traffic generated towards the commerce platform 102 and queries into the IMS database 132 until the user has demonstrated that greater network traffic and database resource allocation is appropriate. Interface generation (e.g., the cart interface 500 of FIG. 5) and initial cart management is performed by the browser using the processing and memory power of the computing device 116.

Initially, the browser, based on the instructions provided by the offer instantiator 118, retrieves the script and offer package 120 from the network storage 112 in the CDN 114 (block 702). The distributive nature of the network storage 112 in the CDN 114, coupled to the relatively low processing and network intense activity of retrieving the script and offer package 120, means that a network traffic surge is not directed at the commerce platform 102 even when a large number of users load the offer instantiator 118 into their browser. The browser, executing the script, instantiates the cart interface in the browser based on the offer package 120 without making any backend calls to the commerce platform 102 (block 704). The browser receives inventory input (e.g., by manipulation of the quantity picker 508, etc.) and estimates the price of the selected inventory based on the offer package 120 without making any backend calls that result in queries to the IMS (block 706). The estimated price may be displayed in the total field 510 of the cart interface 500A. The browser waits until it receives an inventory input or the user interacts with the action button 512 (block 708). When the browser receives an inventory input (“NO” at block 708), the browser estimates the price of the selected inventory based on the offer package 120 without making any backend calls that result in queries to the IMS (block 706).

When the browser detects that the user interacts with the action button 512 (“YES” at block 708), the browser, using the script, instantiates the checkout interface based on the offer package 120 (block 710). The user may return to the cart interface (e.g., return to block 704) at any point. The browser, based on the script, performs a backend call to the commerce platform 102 that includes the currently selected inventory of the cart interface (block 712).

The commerce platform 102, in response to receiving the backend call, calculates a price for the currently selected inventory based on the offer package 120 without generating a query to the IMS of the merchant 104 (block 714). The offer package 120 may include obscured and/or encrypted data that commerce platform 102 is able to unobscure and/or decrypt related to costs beyond the price of the inventory. For example, the commerce platform 102 may calculate the price of the inventory, any fees specified/allowed by the contract with the merchant 104, and/or taxes to be levied on the purchase. This is a relatively low processing cost calculation. The commerce platform 102 returns the calculated price to the browser that issued the backend call (block 716). In some examples, the commerce platform 102 may, on copy of the inventory data object 125, track the inventory position as orders are placed. In such examples, the commerce platform 102 may check to determine whether the goods and/or services indicated by the backend call are available without making a call to the IMS. When the goods and services are not available, the commerce platform 102 may, instead of sending a calculated price to the browser, sends an instruction to cause the browser to refresh and retrieve the offer package 120 and to cause the browser to update the cart interface.

The browser, using the script, displays the calculated price in the checkout interface and performs a browser-side redirect (sometimes referred to as a “client-side redirect”) to the third party payment processor(s) 106 to provide the calculated price (block 718). This allows one or more payment interfaces of the third party payment processor(s) 106 to instantiate within the checkout interface and facilitate payment for the selected inventory. This browser-side redirect means that the resources of the browser, not the commerce platform 102, are used to provide the information necessary for the payment interface(s) to instantiate. Thus, if the user does not proceed with checking out, the network resources used by the user towards the commerce platform 102 have been minimal and no IMS database 132 resources have been expended because of the user.

The browser, using the script, determines whether the user interacts with the checkout button (block 720). When the user does not interact with the checkout button (“NO” at block 720), the browser, using the script, determines whether the user manipulated the selected inventory in the checkout interface (block 722). When the user manipulates the selected inventory (“YES” at block 722), the browser, based on the script, performs a backend call to the commerce platform 102 that includes the currently selected inventory of the cart interface (block 712). When the user does not manipulate the selected inventory (“NO” at block 722), the browser determines whether the user interacts with the checkout button (block 820). When the user interacts with the checkout button (“YES” at block 720), the browser, using the script, performs a backend call that includes the selected inventory (block 724 of FIG. 7B).

The commerce platform 102 generates a purchase intent to define the transactions (block 726). The purchase intent is a record of an offer identifier, a browser identifier, an order identifier, a price, and inventory to be purchased, etc. that facilitates tracking an order beginning from the offer instantiator 118 and the offer package 120 to the checkout process such that any transaction can be audited. The purchase intent is linked to the information necessary to verify the content of the transaction.

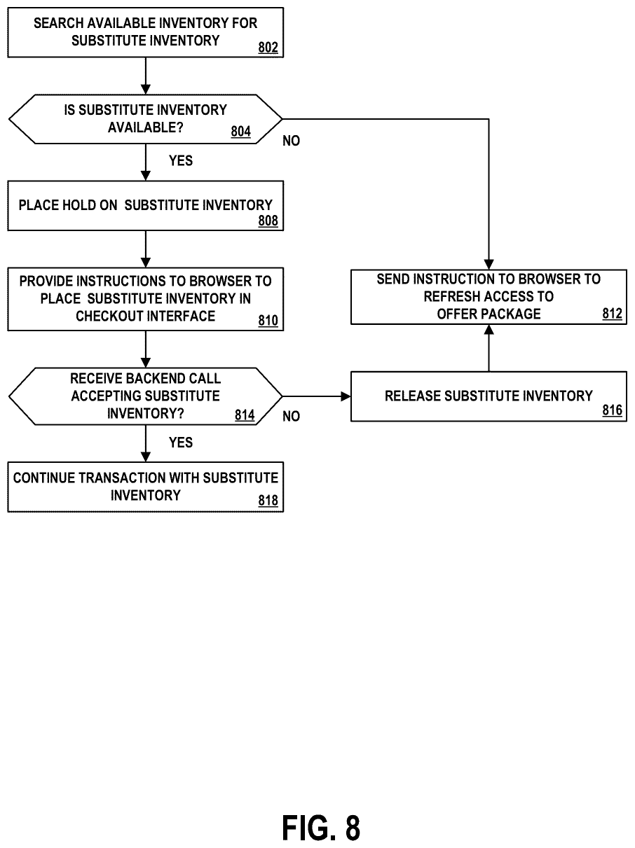

The commerce platform 102 sends a payment intent to the third party payment processor 106 (block 728). The payment intent may cause the third party payment processor 106 to collect payment information from the user (e.g., via the payment processor widget, etc.) and/or place a hold on funds sufficient to pay the calculated cost. The commerce platform 102 then makes a call to the IMS of the merchant 104 to place a reserve on the selected inventory (block 730). The commerce platform 102 determines whether it receives, from the inventory manger 130, confirmation that the selected inventory is available to be reserved (block 732). When the selected inventory is not available (“NO” at block 732), the commerce platform 102 handles the selected inventory not being available (block 734). An example method to handle when the selected inventory is not available is described in connection with FIG. 8 below. In some examples, the commerce platform 102 sets the refresh flag. Otherwise, when the selected inventory is available (“YES” at block 732), the commerce platform 102 signals to the browser that the inventory is reserved (block 736). The reserve temporary prevents the entries in the inventory database 132 representative of the inventory from being reserved or otherwise purchased.

The browser, using the script, presents a first authorization challenge (block 738). In some examples, the authorization challenges may be credentials that the user enters where at least one piece of information for the user to enter is a secret (e.g., a user specified password or passcode, an mobile application-based one-time passcode (e.g., a HMAC-based One-time Password algorithm (HOTP) code, a Time-based One-time Password Algorithm (TOTP) code, etc.), a SMS or email-based one-time password (OTP) code, a code provided by a USB or embedded chip based key (sometimes referred to as a “smartcard” or a “security token”), etc.). Upon entry of the answer to the first authorization challenge, via the script, the browser forwards the entry to the commerce platform 102 to determine if the user passes the first authorization challenge.

The commerce platform 102 determines whether the entry provided by the user passes the first authorization challenge and forwards this determination to the browser (block 740). For example, the user may fail the first authorization challenge by entering a mismatched set of credentials, by entering the wrong OTP, and/or waiting too long to enter the OTP. For example, the user may pass the first authorization challenge by entering a matching set of credentials and/or by entering the correct OTP associated with the identifier.

The browser, using the script, determines whether the user passed the first authorization challenge (block 742). When the user does not pass the first authorization challenge (“NO” at block 742), the browser presents a first authorization challenge again (block 744). In some examples, the browser, using the script, may limit the number of times the first authorization challenge may be attempted before, for example, transmitting a message to the commerce platform 102 to end the transaction (e.g., revoking the payment invent and unreserving the inventory, etc.). When the user does pass the first authorization challenge (“YES” at block 742), the browser, using the script, presents a second authorization challenge (block 744). The second authorization challenge requires entry of different secret information than the first authorization challenge that has a different origin than the secret information of the first authorization challenge. For example, the first authorization challenge may be entry of an OTP received from a SMS message and the second authorization challenge may be entry of a different OTP receive from an email. In some examples, the authorization challenges may be structured such that they may be performed without the user having an account or prior relationship with the commerce platform 102. In some examples, the first authorization challenge may require entry on a mobile phone number to which the commerce platform 102 sends a first OTP, and the second authorization challenge may require entry of an email address to which the commerce platform 102 sends a second OTP. In such examples, these credentials (e.g., the mobile number and email address) may be associated with the purchase intent such that future fulfillment requires entry of the same mobile number-email address pair (e.g., in response to subsequent authorization challenges at the time of fulfillment, etc.). Although two authorization challenges are described wherein, there may be fewer (e.g., one) or more (e.g., three or more) authorization challenges. Upon entry of the answer to the second authorization challenge, via the script, the browser forwards the entry to the commerce platform 102 to determine if the user passes the first authorization challenge.

The commerce platform 102 determines whether the entry provided by the user passes the second authorization challenge and forwards this determination to the browser (block 744). For example, the user may fail the second authorization challenge by entering a mismatched set of credentials, by entering the wrong OTP, and/or waiting too long to enter the OTP. For example, the user may pass the second authorization challenge by entering a matching set of credentials and/or by entering the correct OTP associated with the identifier.

The browser, using the script, determines whether the user passed the second authorization challenge (block 748). When the user does not pass the second authorization challenge (“NO” at block 748), the browser presents a second authorization challenge again (block 744). In some examples, the browser, using the script, may limit the number of times the second authorization challenge may be attempted before, for example, transmitting a message to the commerce platform 102 to end the transaction (e.g., revoking the payment invent and unreserving the inventory, etc.).

When the user passes the second authorization challenge (“YES” at block 748), the commerce platform 102 makes a call to the IMS of the merchant 104 to the selected inventory to be fulfilled (block 750). The commerce platform 102 sends a payment order to the third party payment processor (block 752). The payment order causes the third party payment processor to charge the customer based on the payment intent. The commerce platform changes the purchase intent to a purchase order and prepares for fulfillment (e.g., perform post fulfillment tasks, such as gathering shipping information, etc.) (block 754).

FIG. 8 illustrates an example method to handle when the selected inventory is not available. For example, inventory selected by a customer may not be available because of a transaction sync error. Initially, the commerce platform 102 (e.g., via the transaction API and the ledger manager 602) searches for substitute inventory (block 802). The commerce platform 102 may select substitute inventory based on its similarity to the inventory selected by the customer. Similarity may be determined based on the attributes 316 of the inventory. For example, suitable substitute inventory may be inventory that is one step away from the inventory selected by the customer based on the attributes 316 of the inventory. For example, substitute inventory may be in an adjacent row of a venue or may be a different color of clothing, etc. The commerce platform 102 may use a measurement of similarity to select the substitute (e.g., a simple matching coefficient (SMC), a jaccard coefficient, etc.). The commerce platform 102 determines if substitute inventory is available (e.g., that inventory exists that is sufficiently similar) (block 804). For example, inventory that is one step away from the inventory selected by the customer, based on the attributes 316 of the inventory, may be sufficiently similar. As another example, inventory that has at least a threshold similarity, such as a 0.7 jaccard coefficient, to inventory selected by the customer may be sufficiently similar. When there is not sufficiently similar inventory available (“NO” at block 804), the commerce platform 102 sends instructions to the browser associated with the transaction to refresh access to the offer package 120 (block 806).

Wherein there is sufficiently similar inventory available (“YES” at block 804, the commerce platform 102 instructs the inventory interface 130 to place a hold on the substitute inventory (block 808). The commerce platform 102 sends instructions to the browser associated with the transaction to place the substitute inventory into the checkout interface and inform the customer of the substitution (block 810). The commerce platform 102 determines whether it receives a confirmation that the customer accepts the substitute inventory (block 814). When the customer does accept the substitute inventory (“YES” at block 814), the commerce platform 102 proceeds with the transaction (e.g., make a call to the IMS to reserve the substitute inventory at block 730 of FIG. 7B) (block 814).

When the customer does not accept the substitute inventory (“NO” at block 814), the commerce platform 102 backs a call to the IMS to release the hold status on the substitute inventory (block 816). The commerce platform 102 then sends instructions to the browser associated with the transaction to refresh access to the offer package 120 (block 806).

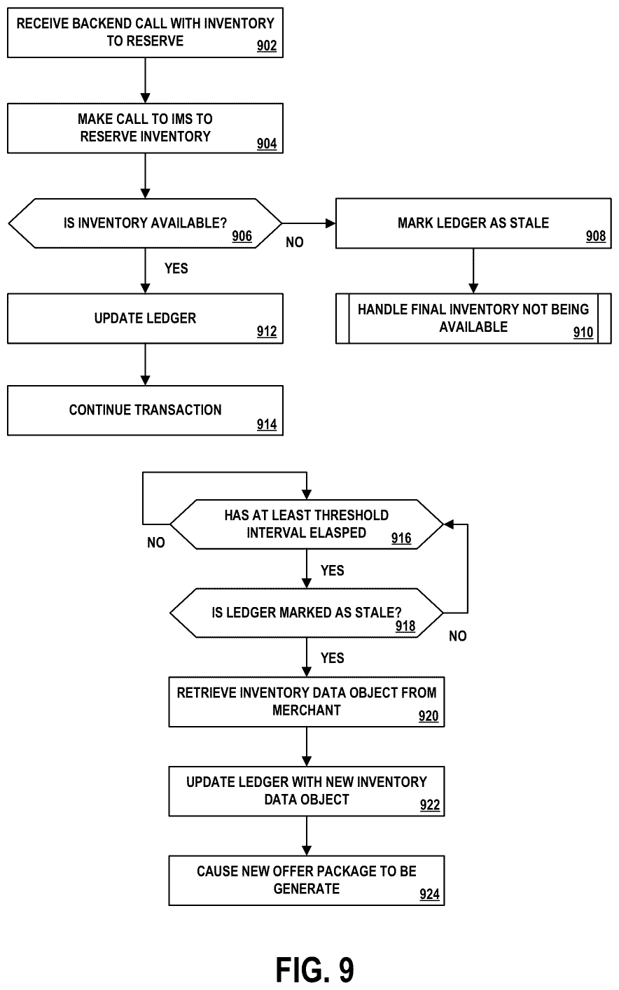

FIG. 9 is a flowchart of an example method to protect an inventory management system during a surge network traffic. The commerce platform 102 receives a backend call with inventory to reserve (block 902). For example, the browser, using the script, performs a backend call that includes the selected inventory to be reserves at block 724 of FIG. 7B. The commerce platform 102 makes a call to the IMS to reserve the requested inventory (block 904). The commerce platform 102 determines whether it receives, from the inventory manger 130, confirmation that the selected inventory is available to be reserved (block 906). When the selected inventory is not available (“NO” at block 906), the commerce platform 102 marks the internal ledger 129 as stale (e.g., sets the refresh flag, etc.) (block 908). The commerce platform 102 handles the selected inventory not being available (block 910). An example method to handle when the selected inventory is not available is described in connection with FIG. 8 above. Otherwise, when the selected inventory is available (“YES” at block 906), the commerce platform 102 updates the status of the inventory in the internal ledger (block 912). The commerce platform 102 then proceeds with the transaction (e.g., signal to the browser that the inventory has been reserved at block 736 of FIG. 7B) (block 914).

From time-to-time, the commerce platform 102 determines whether the refresh interval has elapsed (block 916). The refresh interval may be established by an internal rule and/or an external rule. In some examples, when a refresh interval has been established by both an internal rule and an external rule, the commerce platform adheres to either the refresh interval established by the external rule or the refresh interval that sets a longer interval of time. When the refresh interval has not elapsed (“NO” at block 916), the commerce platform 102 continues to wait. When the refresh interval has not elapsed (“YES” at block 916), the commerce platform 102 determines whether the internal ledger is marked as stale (e.g., the refresh flag has been set) (block 918). When the internal ledger is not marked as stale (“NO” at block 918), the commerce platform 102 continues to wait (block 916).

When the internal ledger is marked as stale (“YES” at block 918), the commerce platform 102 requests or otherwise retrieves an updated version of the inventory data object 125 from the inventory manager 130 (block 920). The commerce platform 102 updated the internal ledger 129 based on the updated version of the inventory data object 125 (block 922). The commerce place 102 generates an updated offer package 120 based on the updated internal ledger 129 (block 924).

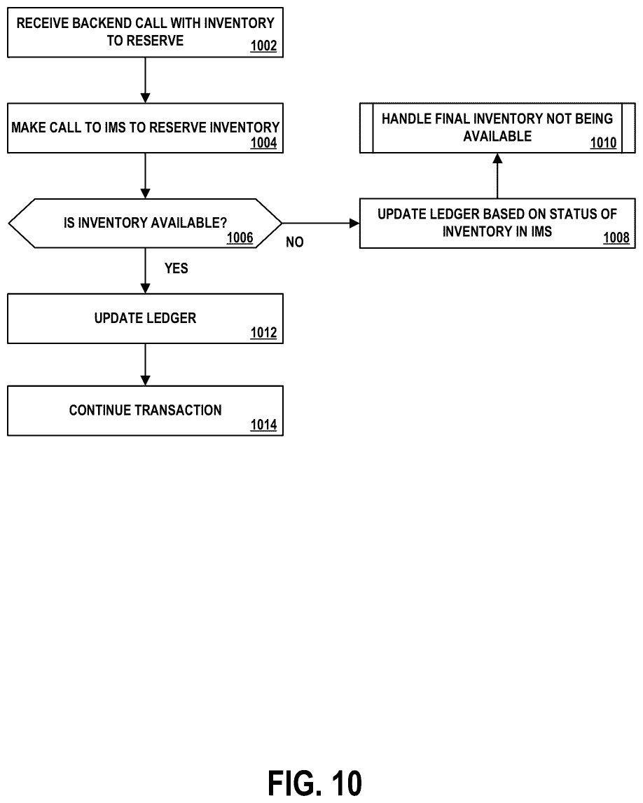

FIG. 10 is a flowchart of an example method to protect an inventory management system during a surge network traffic. The commerce platform 102 receives a backend call with inventory to reserve (block 1002). For example, the browser, using the script, performs a backend call that includes the selected inventory to be reserves at block 724 of FIG. 7B. The commerce platform 102 makes a call to the IMS to reserve the requested inventory (block 1004). The commerce platform 102 determines whether it receives, from the inventory manger 130, confirmation that the selected inventory is available to be reserved (block 906). When the selected inventory is not available (“NO” at block 1006), the commerce platform 102 updates the internal ledger 129 based on the response received from the inventory manager 130 (block 1008). For example, when the response includes the status of the inventory the commerce platform 102 is trying to reserve, the commerce platform 102 may update the internal ledger 102 differently if the inventory currently has a “hold” status than if it has a “reserved” status. In such an example, the commerce platform 102 may treat the inventory with the “hold” status as unavailable for the particular transaction, but may otherwise mark or otherwise maintain it as available in the internal ledger 129. The commerce platform 102 handles the selected inventory not being available (block 1010). An example method to handle when the selected inventory is not available is described in connection with FIG. 8 above. Otherwise, when the selected inventory is available (“YES” at block 1006), the commerce platform 102 updates the status of the inventory in the internal ledger (block 1012). The commerce platform 102 then proceeds with the transaction (e.g., signal to the browser that the inventory has been reserved at block 736 of FIG. 7B) (block 1014).

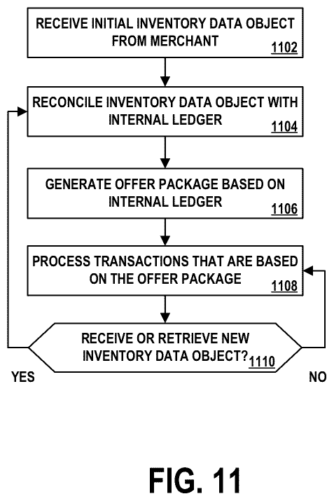

FIG. 11 illustrates an example method to manage the internal ledger 129 to protect an inventory management system during a surge network traffic. Initially, the commerce platform 102 (e.g., via the ledger manager 602) receives an initial version of the inventory data object 125 from the merchant 104 (block 1102). The commerce platform 102 reconciles the inventory data object 125 with the internal ledger 129 (block 1104). In the initial reconciliation, the commerce platform 102 may copy the inventory data object 125 to be the internal ledger 129. The commerce platform 102 generates an offer package 120 based on the internal ledger 129 (block 1106). The commerce platform 102 processes transactions based on the internal ledger 129 (block 1108). In some examples, where there is a transaction frequency limit, the commerce platform may minimize the calls made to the inventory manager 130 while continuing to process transactions. For example, it may take several calls or transaction requests (e.g., ten, twelve, etc.) to the inventory manager 130 to set up a customer in the system of the merchant 104, reserve a good or service, and, mark the reserved inventory for fulfillment. In some examples, the commerce platform 108 may limit calls to the inventory manager 130 to calls to reserve inventory. The commerce platform 102 may then queue transactions to be completed when there are available transaction requests (e.g., after the surge of network traffic has abated, etc.). From time-to-time, the commerce platform 102 determines whether it has received and/or otherwise retrieved an updated version of the inventory data object 125 (block 1110). When it has not received and/or otherwise retrieved an updated version of the inventory data object 125 (“NO” at block 1110), the commerce platform 102 continues to process transactions (block 1108). When it has received and/or otherwise retrieved an updated version of the inventory data object 125 (“YES” at block 1110), the commerce platform 102 reconciles undated version of the inventory data object 125 with the internal ledger 129 (block 1104).

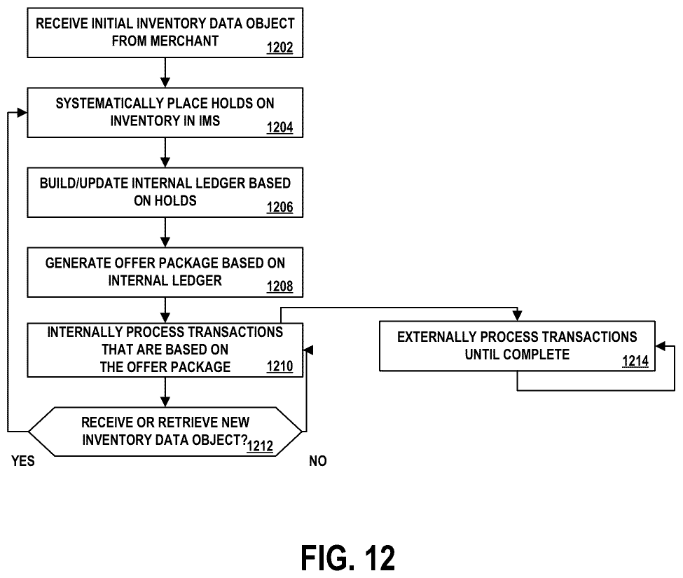

FIG. 12 illustrates an example method to manage the internal ledger 129 to protect an inventory management system during a surge network traffic. Initially, the commerce platform 102 (e.g., via the ledger manager 602) receives an initial version of the inventory data object 125 from the merchant 104 (block 1202). The commerce platform 102 requests, to the inventory manager 130, that holds be placed on as much inventory as possible based on the inventory data object 125 (block 1204). In some examples, the commerce platform 102 requests holds be placed on all of the available inventory as indicated by the inventory data object 125. In some examples, where the inventory data object 125 is not guaranteed to be fresh (e.g., it is a cached version of a portion of the inventory database 132 that is only generated from time-to-time), the commerce platform 102 may use a search-like algorithm to request holds be placed on the available inventory. The commerce platform 102 builds or updates the internal ledger 129 based on the inventory that it successfully places a hold one (block 1206). The commerce platform 102 generates the offer package 120 based on the internal ledger 129 (block 1208). The commerce platform 102 processes transactions based on the internal ledger 129 (block 1210). In some examples, where there is a transaction frequency limit, the commerce platform may minimize the calls made to the inventory manager 130 while continuing to process transactions. For example, it may take several calls or transaction requests (e.g., ten, twelve, etc.) to the inventory manager 130 to set up a customer in the system of the merchant 104, reserve a good or service, and mark the reserved inventory for fulfillment. In some examples, the commerce platform 108 may limit calls to the inventory manager 130 to calls to reserve inventory. The commerce platform 102 may then queue transactions to be completed when there are available transaction requests (e.g., after the surge of network traffic has abated, etc.) (block 1212). From time-to-time, the commerce platform 102 determines whether it has received and/or otherwise retrieved an updated version of the inventory data object 125 (block 1214). When it has not received and/or otherwise retrieved an updated version of the inventory data object 125 (“NO” at block 1214), the commerce platform 102 continues to process transactions (block 1108). When it has received and/or otherwise retrieved an updated version of the inventory data object 125 (“YES” at block 1214), the commerce platform 102 attempts to place holds on inventory based on the updated version of the inventory data object 129 (block 1104).

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

Having thus described the invention, the following is claimed:

1. A network traffic surge resistant system comprising:
network storage; and
one or more servers configured as a commerce platform configured to:
at a first time: (i) generate an internal ledger based on a first version of an inventory data object, (ii) generate a script, an offer package with first inventory slices based on the internal ledger, and an offer instantiator, and (iii) store the script and the offer package onto the network storage, the offer instantiator providing the location of the script and the offer package in the network storage;
at a second time after the first time: (i) receive an updated version of the inventory data object, (ii) reconcile the updated version of the inventory data object with the internal ledger, (iii) generate a second set of inventory slices based on reconciled internal ledger, wherein generating second set of inventory slices does not cause the commerce platform to generate an update signal to any browsers, and (iv) regenerate the offer package that includes the second set of inventory slices and place the regenerated offer package in the same location in the network storage; and
wherein, in response to a browser operating on a computing device accessing the offer instantiator after the first time or the second time: (i) causing, by the offer instantiator, the browser to retrieve the script and the offer package from the network storage, and (ii) causing, by the script, the browser to instantiate a cart interface within the browser based on the offer package using the resources of the computing device without making a backend call to the commerce platform, the cart interface including a set of inventory items based on the first set of inventory slices or the second set of inventory slices.

2. The system of claim 1, wherein before the second time, the commerce platform is configured to request the updated version of the inventory data object in response to a trigger.

3. The system of claim 2, wherein the trigger is based on multiple flags being set in memory.

4. The system of claim 3, wherein the commerce platform is configured to (i) set a first flag in response to, after the commerce platform requests selected inventory to be reserved by an inventory management system that inventory, receiving a response that the selected inventory is not available, and (ii) set a second flag after a threshold period of time after the updated version of the inventory data object was last received.

5. The system of claim 1, wherein reconciling the updated version of the inventory data object with the internal ledger comprises modifying internal ledger based on predetermined rules when the internal ledger disagrees with the updated version of the inventory data.

6. The system of claim 5, wherein the predetermined rules depend on a freshness of the updated version of the inventory data object.

7. The system of claim 1, wherein generating the internal ledger based on the first version of an inventory data object comprises:
requesting an inventory management system to place a hold status on inventory based on the first version of an inventory data object; and
generating the internal ledger based on the inventory that inventory management system successfully placed a hold status on.

8. The system of claim 7, wherein to request the inventory management system to place a hold status on inventory based on the first version of an inventory data object, the commerce platform is configured to perform the requests base on a search algorithm.

9. The system of claim 1, wherein an inventory management system imposes a limit on requests per minute, and wherein the second time is triggered based on internal rules that manage a frequency of requests made by the commerce platform to the inventory management system.

10. The system of claim 1, wherein to cause the browser to instantiate the cart interface, the script generates instructions, using the resources of the computing device, for the browser to execute based on the offer package.

11. A method for protecting an inventory management system by a network traffic surge resistant platform, the method comprising:
at a first time, by one more servers configured to operate as a commerce platform:
generating an internal ledger based on a first version of an inventory data object;
generating a script, an offer package with first inventory slices based on the internal ledger, and an offer instantiator; and
storing the script and the offer package onto a network storage, the offer instantiator providing the location of the script and the offer package in the network storage;
at a second time after the first time, by the commerce platform:
receiving an updated version of the inventory data object from the inventory management system;
reconciling the updated version of the inventory data object with the internal ledger;
generating a second set of inventory slices based on reconciled internal ledger, wherein generating a second set of inventory slices does not cause the commerce platform to generate an update signal to any browsers; and
regenerating the offer package that includes the second set of inventory slices and place the regenerated offer package in the same location in the network storage;
wherein, in response to a browser operating on a computing device accessing the offer instantiator after the first time and before the second time:
causing, by the offer instantiator, the browser to retrieve the script and the offer package from the network storage, and
causing, by the script, the browser to instantiate a cart interface within the browser based on the offer package using the resources of the computing device without making a backend call to the commerce platform, the cart interface including a first set of inventory items based on the first set of inventory slices; and
wherein, in response to a browser operating on a computing device accessing the offer instantiator after the second time:
causing, by the offer instantiator, the browser to retrieve the script and the offer package from the network storage, and
causing, by the script, the browser to instantiate a cart interface within the browser based on the offer package using the resources of the computing device without making a backend call to the commerce platform, the cart interface including a second set of inventory items based on the second set of inventory slices.

12. The method of claim 1, wherein the method further comprises, before the second time, requesting, by the commerce platform, the updated version of the inventory data object in response to a trigger.

13. The method of claim 12, wherein the trigger is based on multiple flags being set in memory.

14. The method of claim 13, further comprising, by the commerce platform, (i) setting a first flag is set in response to, after the commerce platform requests selected inventory to be reserved by an inventory management system that inventory, receiving a response that the selected inventory is not available, and (ii) setting a second flag after a threshold period of time after the updated version of the inventory data object was last received.

15. The method of claim 11, wherein reconciling the updated version of the inventory data object with the internal ledger comprises modifying internal ledger based on predetermined rules when the internal ledger disagrees with the updated version of the inventory data.

16. The method of claim 15, wherein the predetermined rules depend on a freshness of the updated version of the inventory data object.

17. The method of claim 11, wherein generating the internal ledger based on the first version of an inventory data object comprises:
requesting an inventory management system to place a hold status on inventory based on the first version of an inventory data object; and
generating the internal ledger based on the inventory that inventory management system successfully placed a hold status on.

18. The method of claim 17, wherein to request the inventory management system to place a hold status on inventory based on the first version of an inventory data object, the commerce platform is configured to perform the requests base on a search algorithm.

19. The method of claim 11, wherein an inventory management system imposes a limit on requests per minute, and wherein the second time is triggered based on internal rules that manage a frequency of requests made by the commerce platform to the inventory management system.

20. The method of claim 11, wherein to cause the browser to instantiate the cart interface, generating instructions, by the script, using the resources of the computing device, for the browser to execute based on the offer package.
